(19) United States
(12) Patent Application Publication
(10) Pub. No.: US 2026/0221749 A1
(43) Pub. Date: Jul. 30, 2026

(54) OVERVOLTAGE PROTECTION DEVICES WITH TEMPERATURE-BASED FAILSAFE

(71) Applicant: Southwire Company, LLC, Carrollton, GA (US)

(72) Inventors: Donald Paul Oldham, JR., Trinity, FL (US); Kyle Curry, Palm Harbor, FL (US)

(21) Appl. No.: 19/461,000

(22) Filed: Jan. 27, 2026

Related U.S. Application Data
(60) Provisional application No. 63/750,648, filed on Jan. 28, 2025.

(51) Int. Cl. H02H 3/02; H01C 7/12; H01H 85/04; H02H 3/20; H02H 7/20; H01H 85/02

(52) U.S. Cl. CPC H02H 3/023; H01C 7/126; H01H 85/04; H02H 3/20; H02H 7/20; H01H 2085/0275

(57) ABSTRACT

An overvoltage protection device with temperature-based fail safe is provided. The overvoltage protection device may include one or more overvoltage protection components and a failsafe component. The failsafe component may include a first set of one or more electrical contacts on a first substrate, a second set of one or more electrical contacts on a second substrate, and a spacer configured to space apart the first set of one or more electrical contacts and the second set of one or more electrical contacts when coupled to at least one of the first or second substrates via a thermal sensitive component. The spacer may be configured to decouple from one or both of the first and second substrates when the thermal sensitive component is exposed to at least a threshold temperature corresponding to the heat generated by at least one overvoltage protection component to create a short circuit.

### CROSS-REFERENCE TO RELATED APPLICATIONS

This application claims priority to U.S. Provisional Patent Application No. 63/750,648, filed on Jan. 28, 2025, which is incorporated herein by reference in its entirety.

### FIELD OF INVENTION

The present disclosure relates generally to overvoltage protection devices. Example embodiments are directed to overvoltage protection devices with temperature-based failsafe.

### BACKGROUND

Power supply systems for supplying power to electrical equipment (e.g., electronics, electrical installations, etc.), whether in residential buildings, commercial buildings, telecommunication systems, or the like, may experience excessive voltage due to a variety of reasons. For example, lightning strikes, voltage surges during switching operations, or faults in the main power supply source, may cause excessive voltage in a power supply system for supplying power to electrical equipment. Such excessive voltage can cause damage to the electrical equipment.

Overvoltage protection components, such as varistors, may be employed to absorb excessive voltage in a power supply system in order to protect the electrical equipment being supplied power by the power supply system. In particular, an overvoltage protection device (e.g., surge protective device) comprising one or more overvoltage protection components may be designed and installed in a power supply system for supplying power to electrical equipment to protect the electrical equipment against excessive voltage in the power supply system.

Many overvoltage protection components, including varistors, tend to fail-often in a volatile manner-from overcurrent, overheating, and/or explosion at their end of life or due to other reasons including faults with the overvoltage protection components or other components of the surge protective device. Existing overvoltage protection devices are generally designed to disconnect from the power supply system when overvoltage protection components thereof reach their end of life or otherwise fail. However, by disconnecting from the power supply system, the electrical equipment being supplied power by the power supply system is left unprotected from any excessive voltage that may result.

Through applied effort, ingenuity, and innovation, Applicant has solved problems related to overvoltage protection devices including, but not limited to, the above noted challenges and problems in existing overvoltage protection devices.

### BRIEF SUMMARY

According to one aspect of the present disclosure an overvoltage protection device with temperature-based failsafe is provided. In various embodiments, the overvoltage protection device includes an overvoltage protection device comprising one or more overvoltage protection components, wherein at least one overvoltage protection component of the one or more overvoltage protection components generates heat when at its end of life; and a failsafe component in thermal communication with the one or more overvoltage protection components, the failsafe component comprising a first set of one or more electrical contacts on a first surface of a first substrate; a second set of one or more electrical contacts on a second surface of a second substrate, wherein the first surface and the second surface face each other; and a spacer between the first surface and the second surface configured to space apart the first set of one or more electrical contacts and the second set of one or more electrical contacts when the spacer is coupled to at least one of the first substrate or the second substrate via a thermal sensitive component such that the failsafe component is biased to a non-conductive configuration; wherein the spacer is configured to decouple from one or both of the first substrate and the second substrate when the thermal sensitive component is exposed to at least a threshold temperature corresponding to the heat generated by the at least one overvoltage protection component to cause the failsafe component to transition to a conductive configuration; and wherein the first set of one or more electrical contacts and the second set of one or more electrical contacts are in contact with each other when in the conductive configuration and create a short circuit to interrupt power supply.

In some example embodiments, each of the one or more overvoltage protection devices comprises a varistor.

In some example embodiments, at least one of the one or more overvoltage protection components comprises an MOV.

In some example embodiments, each of the first substrate and the second substrate comprises a circuit board.

In some example embodiments, the thermal sensitive component comprises a low temperature melting alloy.

In some example embodiments, the thermal sensitive component has a melting temperature that is less than or equal to the threshold temperature.

In some example embodiments, the spacer comprises a first end and a second end.

In some example embodiments, the spacer is coupled to the first substrate when the failsafe component is biased to a non-conductive, and the first substrate is positioned above relative to the second substrate and defines a through hole having an interior that surrounds the first end of the spacer when the spacer is coupled to the first substrate.

In some example embodiments, the failsafe component further comprises a compressible component configured to bias the first surface of the first substrate and the second surface of the second substrate towards each other.

In some example embodiments, the first set of one or more electrical contacts and the second set of one or more electrical contacts define at least one electrical contact pair comprising a first electrical contact and a second electrical contact that are aligned relative to each other.

In some example embodiments, the one or more overvoltage protection components form a stack of overvoltage protection components comprising a first overvoltage protection component set and a second overvoltage protection component set, wherein the failsafe component is positioned between the first overvoltage protection component set and the second overvoltage protection component set.

In some example embodiments, the overvoltage protection device further comprises a third substrate, wherein each of the one or more overvoltage protection components and the failsafe component is coupled to the third substrate.

In some example embodiments, the failsafe component further comprises a first jumper cable coupled to the first substrate and the third substrate; and a second jumper cable coupled to the second substrate and the third substrate.

In some example embodiments, the third substrate comprises a circuit board.

In some example embodiments, the spacer is made from copper.

In some example embodiments, the threshold temperature is about 125° C.

In some example embodiments, at least a first portion of the one or more overvoltage protection components is electrically coupled between a powered line and a return line, and wherein at least a second portion of the one or more overvoltage protection components is electrically coupled between the return line and an electrical ground.

In some example embodiments, the powered line and the return line are connected to a power supply system configured to supply power to electrical equipment.

In some example embodiments, the power supply system is a telecommunications power supply system.

In some example embodiments, the overvoltage protection device further comprises a housing configured to house the one or more overvoltage protection components and the failsafe component.

### BRIEF DESCRIPTION OF THE DRAWINGS

Reference will now be made to the drawings, which are not necessarily drawn to scale, and wherein:

FIG. 1 shows an example overvoltage protection circuit of an overvoltage protection device in accordance with at least one example embodiment of the present disclosure.

FIG. 2 shows an example telecommunications power supply system in which an overvoltage protection device may be used in accordance with at least one example embodiment of the present disclosure.

FIGS. 3A-E show various views of an overvoltage protection device in accordance with at least one example embodiment of the present disclosure.

FIG. 3F shows a failsafe component in accordance with at least one example embodiment of the present disclosure.

FIGS. 3G-I show various views of an overvoltage protection device in accordance with at least one other example embodiment of the present disclosure.

FIGS. 3J-L show various views of an overvoltage protection device in accordance with at least one other example embodiment of the present disclosure.

FIGS. 3M-P show various views of an overvoltage protection device in accordance with at least one other example embodiment of the present disclosure.

FIGS. 3Q-V show various views of an overvoltage protection device in accordance with at least one other example embodiment of the present disclosure.

FIG. 4 shows a schematic diagram of an overvoltage protection system in accordance with at least one example embodiment of the present disclosure.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term "or" is used herein in both the alternative and conjunctive sense, unless otherwise indicated. Like numbers refer to like elements throughout.

Various embodiments of the present disclosure are directed to an overvoltage protection device for detecting and protecting against overvoltage condition (e.g., excessive voltage) in a power supply system configured for supplying power to electrical equipment. In particular, the overvoltage protection device is configured to protect electrical equipment being supplied power by the power supply system from excessive voltage. The overvoltage protection device is configured to be installed in the power supply system. For example, the overvoltage protection device may be installed between power supply line(s) and electrical ground across electrical equipment. In some embodiments, the overvoltage protection device is configured to protect the electrical equipment against other fault conditions. By way of example, such other fault conditions may include open neutral condition, low voltage condition, and/or the like. The power supply system may be a split-phase power system, a single-phase power system, a three-phase power system, a direct current (DC) power supply system, or any other power supply system.

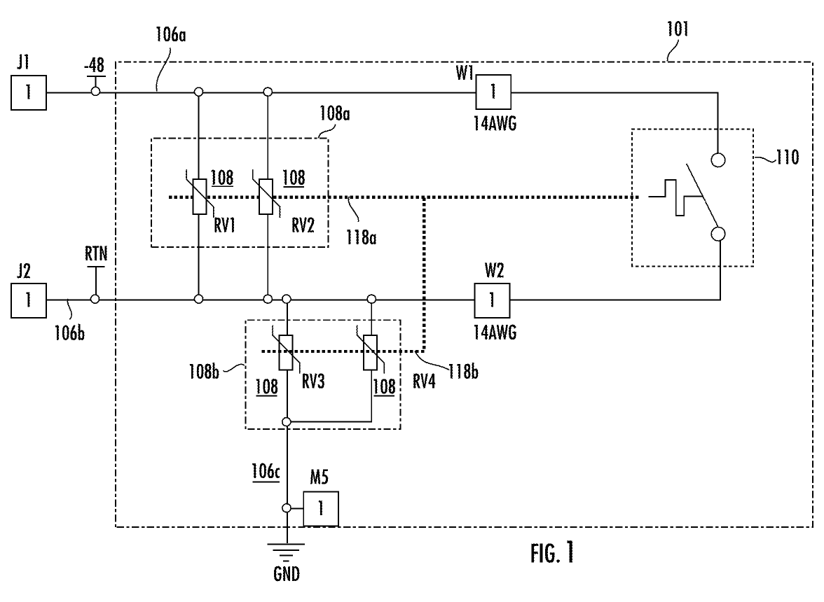

FIG. 1 shows an example overvoltage protection circuit 101 of an overvoltage protection device 100 in accordance with at least one embodiment of the present disclosure. The depiction of the overvoltage protection circuit 101 is not intended to limit or otherwise confine the embodiments described and contemplated herein to any particular configuration nor is it intended to exclude any alternative configuration that can be used in connection with embodiments of the present disclosure. It will be understood that while many of the aspects and components presented in FIG. 1 are shown as discrete, separate elements, other configurations may be used in connection with the methods, devices, and systems described herein, including configurations that combine, omit, separate, and/or add aspects and/or components.

In the illustrated embodiment of FIG. 1, the overvoltage protection circuit 101 comprises one or more electrical lines 106a-c, one or more overvoltage protection components 108, and a failsafe component 110. In some embodiments, the overvoltage protection device 100 is configured to function at least in part as a surge protective device.

In the illustrated embodiment of FIG. 1, the one or more electrical lines 106a-c comprise a powered line 106a (e.g., powered conductor lines), a return line 106b (e.g., neutral line), and a ground line 106c. In other embodiments, the overvoltage protection circuit 101 may comprise a plurality of powered lines. The one or more electrical lines 106a-c are configured to be connected to electrical lines in a power supply system. In particular, the overvoltage protection device 100 may be installed in a power supply system via the one or more electrical lines 106a-c. The powered line 106a may be electrically coupled to a powered line of the power supply system. The return line 106b may be electrically coupled to a return line of the power supply system. The ground line 106c may be electrically coupled to a ground line of the power supply system. By way of example, the power supply system may be a single-phase power supply system configured to provide a single-phase power to electrical equipment, a three-phase power supply system configured to provide a three-phase power to electrical equipment, a split-phase power supply system configured to provide a split-phase power to electrical equipment, a DC power supply system configured to provide DC power to electrical equipment, or any other power supply system configured to provide power to electrical equipment.

The one or more overvoltage protection components 108 are configured to protect electrical equipment being supplied power by the power supply system from overvoltage condition in the power supply system. In various embodiments, the one or more overvoltage protection components 108 comprise one or more varistors. The one or more varistors may be any of a plurality of varistor types such as, but not limited, to metal oxide varistor (MOV). In various embodiments, each of the one or more overvoltage protection components 108 comprise an MOV. The one or more overvoltage protection components 108 may be arranged to form a stack of overvoltage protection components 108. For example, the one or more overvoltage protection components may form a stack of overvoltage protection components comprising a first overvoltage protection component set 108a and a second overvoltage protection component set 108b. For example, in some embodiments, the one or more overvoltage protection components 108 comprise a stack of MOVs.

It would be appreciated that an overvoltage protection component 108 may be any suitable device capable of protecting electrical equipment from an overvoltage condition. For example, in some embodiments, the one or more overvoltage protection components 108 may, alternatively or additionally, comprise transient voltage suppression (TVS) diodes and/or Zener diodes.

The one or more overvoltage protection components 108 may be configured to create a low resistance shunt path for overvoltage current when an overvoltage condition is present in the power supply system, which reduces or otherwise mitigates against damage to the electrical equipment being supplied by the power supply system. An overvoltage protection component 108, such as a varistor, has a clamping voltage wherein the overvoltage protection component 108 creates a low resistance shunt path for overvoltage current (resulting from overvoltage condition) in the power supply system, thereby protecting the electrical equipment from damage by the overvoltage current.

In various embodiments, at least a portion of the one or more overvoltage protection components 108 is electrically coupled between the powered line 106a and the return line 106b of the overvoltage protection device 100. Alternatively, or additionally, in various embodiments, at least a portion of the one or more overvoltage protection components 108 is electrically coupled between the return line 106b and the ground line 106c of the overvoltage protection device 100.

The one or more overvoltage protection components 108 may comprise one or more sets of overvoltage protection components 108, each comprising one or more varistors. For example, in some embodiments, the set of one or more overvoltage protection components 108 may comprise one or more MOVs. In the illustrated example embodiment of FIG. 1, the one or more overvoltage protection components 108 comprises a first overvoltage protection component set 108a comprising a first pair of varistors 108 between the powered line 106a and the return line 106b. Additionally, the one or more overvoltage protection components 108 comprises a second overvoltage protection component set 108b. In some embodiments, the second overvoltage protection component set 108b comprises a pair of varistors 108 (e.g., a second pair of varistors 108) between the return line 106b and the ground line 106c. Alternatively or additionally, in some embodiments, the second overvoltage protection component set 108b comprises a pair of varistors 108 between the powered line 106a and the ground line 106c. The pairs of varistors 108 may be connected in parallel relative to one another. For example, the first pair of varistors 108 may be connected in parallel relative to one another and the second pair of varistors 108 may be connected in parallel relative to one another.

It would be appreciated that in some embodiments, the one or more overvoltage protection components 108 may comprise less than or greater than two varistors 108 between the powered line 106a and the return line 106b. Further, it would be appreciated that in some embodiments, the one or more overvoltage protection components 108 may comprise less than or greater than two varistors 108 between the return line 106b and the ground line 106c.

As further described below, in an example embodiment, the powered line 106a is a -48VDC powered line configured for being coupled to a -48VDC powered line of a power supply system for supplying power to electrical equipment such as, but not limited to, telecommunications electrical equipment (e.g., 5G cell tower radio, telecommunications ground equipment, or the like).

In various embodiments, the path between the powered line 106a and the return line 106b corresponds to the powered line and return line in the power supply system defining a first overvoltage mode (e.g., a circuit path in the power supply system that may experience overvoltage). In this regard, the first overvoltage protection component set 108a between the powered line 106a and the return line 106b represents a mode of protection between the powered line and the return line (e.g., powered conductor-to-return mode of protection) in the power supply system. For example, the first overvoltage protection component set 108a between the powered line 106a and the return line 106b may be configured to protect against overvoltage condition that occurs between the powered line and the return line in the power supply system.

In various embodiments, the path between the return line 106b and the ground line 106c corresponds to the return line and ground line in the power supply system defining a second overvoltage mode (e.g., another circuit path in the power supply system that may experience overvoltage). In this regard, the second overvoltage protection component set 108b between the return line 106b and the ground line 106c represents a mode of protection between the return line and the ground line (e.g., return-to-ground mode of protection) in the power supply system. For example, the second overvoltage protection component set 108b between the return line 106b and the ground line 106c may be configured to protect against overvoltage condition that occurs between the return line and the ground line in the power supply system.

In various embodiments, the path between the powered line 106a and the ground line 106c corresponds to the powered line and ground line in the power supply system defining a third overvoltage mode (e.g., another circuit path in the power supply system that may experience overvoltage). In this regard, the first overvoltage protection component set 108a between the powered line 106a and the return line 106b and the second overvoltage protection component set 108b between the return line 106b and the ground line 106c may collectively represent a mode of protection between the powered line and the ground line (e.g., powered conductor-ground mode of protection or powered conductor-return-ground mode of protection) in the power supply system.

In this regard, the overvoltage protection device 100 may include a first mode of protection, a second mode of protection, and/or a third mode of protection, as described above. It would be appreciated that in some other embodiments, the overvoltage protection device 100 may not include one or more of the first mode of protection, the second mode of protection, or the third mode of protection.

In various embodiments, the failsafe component 110 is configured to react to a failure condition (e.g., device failure condition) with the overvoltage protection device 100, including a failure condition with an overvoltage protection component 108 thereof. In various embodiments, the failsafe component 110 is configured to react to a failure condition with any of the one or more overvoltage protection components 108. For example, in embodiments where the first overvoltage protection component set 108a and the second overvoltage protection component set 108b comprise varistors, the failsafe component 110 may be configured to react to a failure condition with any of the varistors of the first overvoltage protection component set 108a and a failure condition to any of the varistors of the second overvoltage protection component set 108b. In some embodiments, such failure condition may occur at the end of life of the respective overvoltage protection component 108 or due to a fault associated with the overvoltage protection component 108.

In various embodiments, the failsafe component 110 is configured to mitigate or otherwise protect against the potential effects of a failure condition with the overvoltage protection device 100. In particular, the failsafe component 110 is configured to protect electrical equipment being supplied power by the power supply system from damage due to failure of an overvoltage protection component 108 of the overvoltage protection device 100, which may occur at the end of life of the overvoltage protection component 108. Such failure, for example, may expose the electrical equipment to excess current from overvoltage condition and/or excessive heat.

As described above an overvoltage protection component 108 may comprise a varistor. Varistors and many other types of overvoltage protection components tend to fail-often in a volatile manner-from overcurrent, overheating, and/or explosion at their end of life or due to other reasons. This in turn creates safety hazards such as fire hazards and renders the electrical equipment unprotected from future potential overvoltage conditions. Varistors are generally voltage-dependent and configured to provide overvoltage protection based on voltage clamping. When the voltage across the varistor exceeds the varistor clamping voltage (e.g., rated voltage value), the varistor's resistance decreases (e.g., with increasing voltage) and the varistor goes into a conducting mode such that current (e.g., leakage current) flows through the varistor. Varistors and many other overvoltage protection components degrade gradually as they are exposed or otherwise subjected to overvoltage current due to overvoltage conditions. The clamping voltage of varistors, for example, drop overtime as they are exposed or otherwise subjected to overvoltage current resulting from overvoltage conditions. As the varistor's clamping voltage drops, the leakage current increases and may cause the varistor to overheat and/or result in thermal runaway when a certain leakage current threshold is exceeded.

The failsafe component 110 is configured to react when an overvoltage protection component 108 overheats or otherwise fails. In various embodiments, the failsafe component 110 is configured to create a short circuit when an overvoltage protection component 108 generates heat corresponding to a temperature that exceeds a threshold temperature so as to protect against the potential effects of the failure condition, including damage to electrical equipment and safety hazards. In various embodiments, the short circuit causes power supplied by the power supply system to be interrupted. For example in some embodiments, the failsafe component 110 is configured to cause power to the electrical equipment to be shunted back to the source (e.g., power supply) when an overvoltage protection component 108 generates heat corresponding to a temperature that exceeds a threshold temperature. The power supply may then be interrupted via a power source circuit breaker, a fuse, an electronic power supply, or the like. For example, the shunt may cause a power source circuit breaker, a fuse, an electronic power supply, or the like connected to or otherwise associated with the power supply to shut off in order to interrupt the power supply.

The failsafe component 110 is in thermal communication with the one or more overvoltage protection components 108 such that heat generated by an overvoltage protection component 108 is conducted to the failsafe component 110. In this regard, the failsafe component 110 is exposed to a temperature that corresponds to the heat conducted by an overvoltage protection component 108 when the overvoltage protection component 108 is at its end of life or otherwise fails.

In the illustrated example shown in FIG. 1, the failsafe component 110 is in thermal communication with the first overvoltage protection component set 108a and/or in thermal communication with the second overvoltage protection component set 108b. The failsafe component 110, for example, may be in thermal communication with both the first overvoltage protection component set 108a and the second overvoltage protection component set 108b. The dashed line 118a depicted in FIG. 1 represents thermal conductivity (e.g., heat transfer) from the first overvoltage protection component set 108a to the failsafe component 110. The dashed line 118b depicted in FIG. 1 represents thermal conductivity from the second overvoltage protection component set 108b to the failsafe component 110.

As further described below, in various embodiments, the failsafe component 110 is configured to transition from a non-conductive configuration to a conductive configuration in response to being exposed to a temperature that satisfies (e.g., exceeds, is equal to, or the like) the threshold temperature. For example, the failsafe component 110 may function as a switch configured to switch from one state to another when exposed to a temperature that satisfies the threshold temperature. For example, the failsafe component 110 may function as a normally open temperature switch configured to close (e.g., change from the normally open state to a closed state) when exposed to temperature that satisfies a threshold temperature. In various embodiments, the threshold temperature is selected such that it is less than or equal to the maximum normal operating temperature of certain components (e.g., some or all) of the overvoltage protection device 100.

In various embodiments, the failsafe component 110 is configured to cause the power supplied by the power supply system to be interrupted when the failsafe component 110 transitions from the non-conductive configuration to the conductive configuration. In particular, in various embodiments, the conductive configuration creates a short circuit, which in turn, causes power supplied by the power supply system to be interrupted.

In some embodiments, the power supply system is coupled to or otherwise comprises a power source circuit breaker. In such some embodiments, the failsafe component 110 is electrically coupled to a power source circuit breaker configured to cause the power source circuit breaker to interrupt power supplied by the power supply system when the failsafe component 110 transitions from a non-conductive configuration to a conductive configuration that creates a short circuit. In some embodiments, the power supply system is coupled to or otherwise comprises a power source circuit breaker. In such some embodiments, the failsafe component 110 is electrically coupled to a power source circuit breaker configured to cause the power source circuit breaker to interrupt power supplied by the power supply system when the failsafe component 110 transitions from a non-conductive configuration to a conductive configuration that creates a short circuit. In various embodiments, the overvoltage protection device 100 is configured for being installed in any of a plurality of power supply systems such as, but not limited to, a telecommunications power supply system.

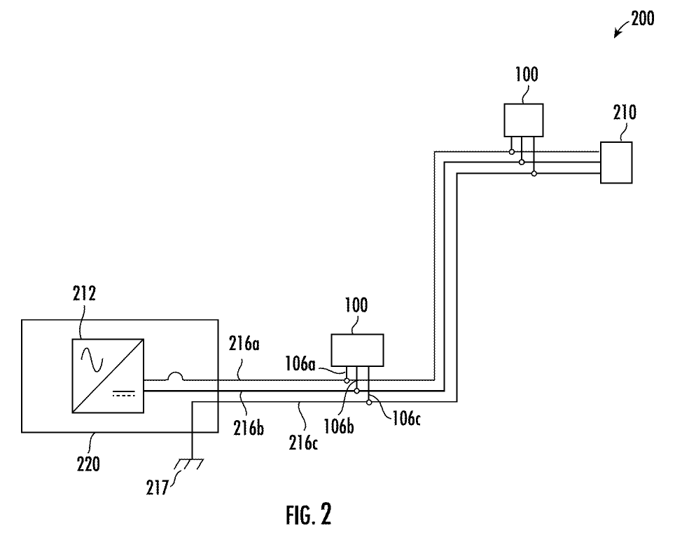

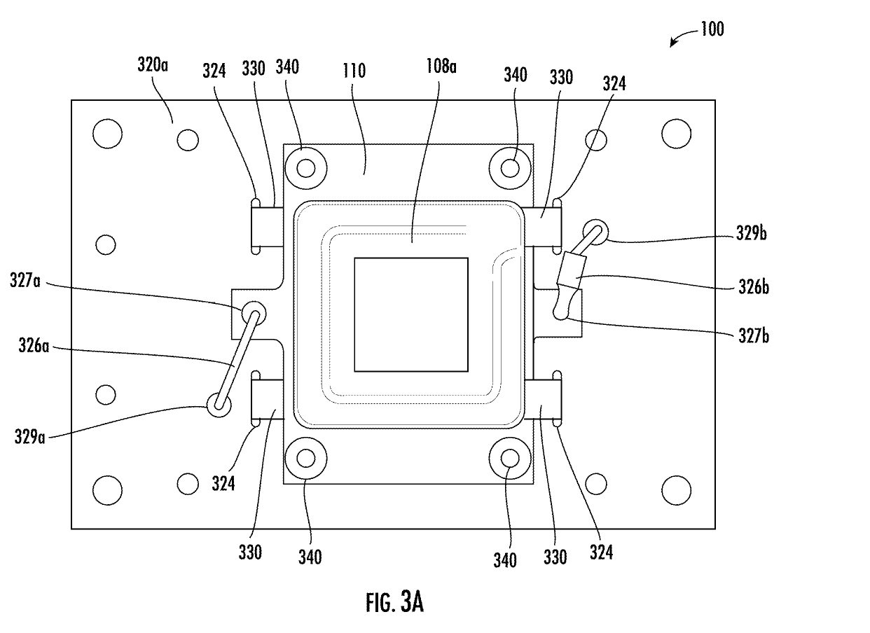

FIG. 2 shows a telecommunications power supply system 200 in which an overvoltage protection device 100 may be used in accordance with at least one embodiment of the present disclosure. The telecommunications power supply system 200 may be configured for supplying power to telecommunications electrical equipment such as, but not limited to, tower equipment 210 (e.g., 5G cell tower radios or the like) and/or ground equipment 212. The ground equipment 212 may comprise a power supply component 220 such as, for example, an alternating current (AC) to direct current (DC) power converter (AC-DC power converter).

As shown in FIG. 2, an overvoltage protection device 100 may be installed and used in the telecommunications power supply system 200 to protect the tower equipment 210. Alternatively, or additionally, an overvoltage protection device 100 may be installed and used in the telecommunications power supply system 200 to protect the ground equipment 212. For example, a first overvoltage protection device 100 and a second overvoltage protection device 100 may be installed and used in a telecommunications power supply system 200 to protect the tower equipment 210 and the ground equipment 212, respectively.

The telecommunications power supply system 200 may be configured to provide a -48V direct current (e.g., -48VDC) power. For example, the telecommunications power supply system 200 may comprise a powered line 216a (which may be a -48VDC powered line), a return line 216b, and a ground line 216c connected to an electrical ground 217. As shown in FIG. 2, the ground equipment 212 may be electrically coupled to the powered line 216a and the return line 216b of the telecommunications power supply system 200. As further shown in FIG. 2, the tower equipment 210 may be electrically coupled to the powered line 216a, return line 216b, and ground line 216c of the telecommunications power supply system 200.

An overvoltage protection device 100 may configured for being electrically coupled to the telecommunications power supply system 200 via the powered line 106a, return line 106b, and ground line 106c of the overvoltage protection device 100 and the powered line 216a, return line 216b, and ground line 216c of the telecommunications power supply system 200. As shown in FIG. 2, the powered line 106a of the overvoltage protection device 100 may be configured for being electrically coupled to the powered line 216a of the telecommunications power supply system 200. As shown in FIG. 2, the return line 106b of the overvoltage protection device 100 may be configured for being electrically coupled to the return line 216b of the telecommunications power supply system 200. As further shown in FIG. 2, the ground line 106c of the overvoltage protection device 100 may be configured for being electrically coupled to the ground line 216c of the telecommunications power supply system 200.

In some examples, the ground equipment 212 is housed in an electrical cabinet. In some embodiments, an overvoltage protection device 100 may be configured for being housed within the electrical cabinet (or a portion thereof). Alternatively, or additionally, in some embodiments, an overvoltage protection device 100 may be configured for being housed in an outside enclosure mounted proximate to, or near, the base of the telecommunications cell tower.

In some embodiments, the telecommunications power supply system 200 may be coupled to or otherwise include at least one power source circuit breaker. In some embodiments, the overvoltage protection device 100 is electrically coupled to the power source circuit breaker. In some embodiments, the overvoltage protection device 100 (e.g., failsafe component 110 thereof) causes the circuit breaker to interrupt power supplied by the telecommunications power supply system 200 to the electrical equipment (e.g., tower equipment 210, ground equipment 212) in response to a failure condition with the overvoltage protection device 100. In some embodiments, the power source circuit breaker is upstream relative to the telecommunications cell tower. Alternatively, or additionally, in some embodiments, the power source circuit breaker is located within the electrical cabinet.

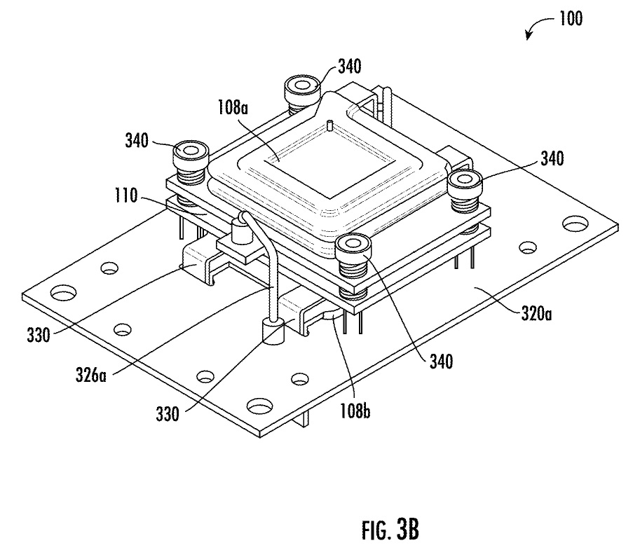

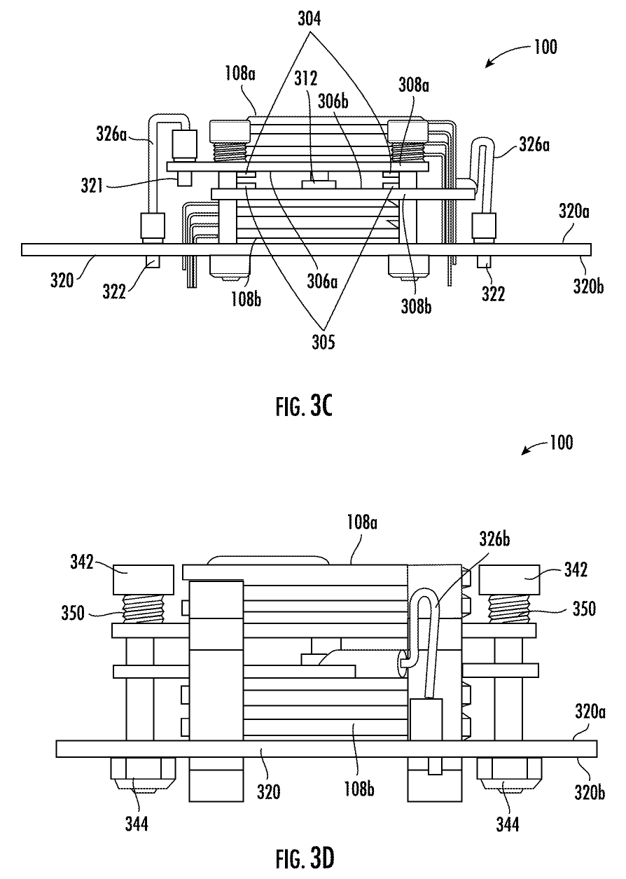

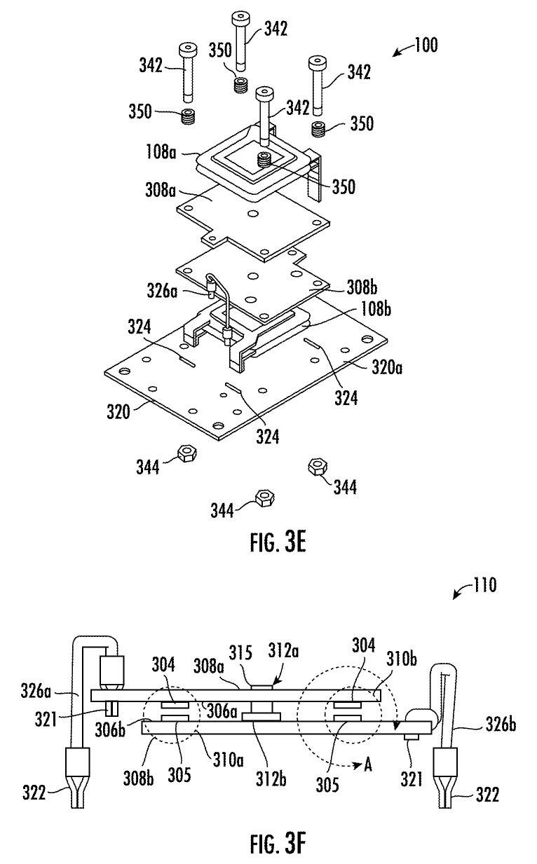

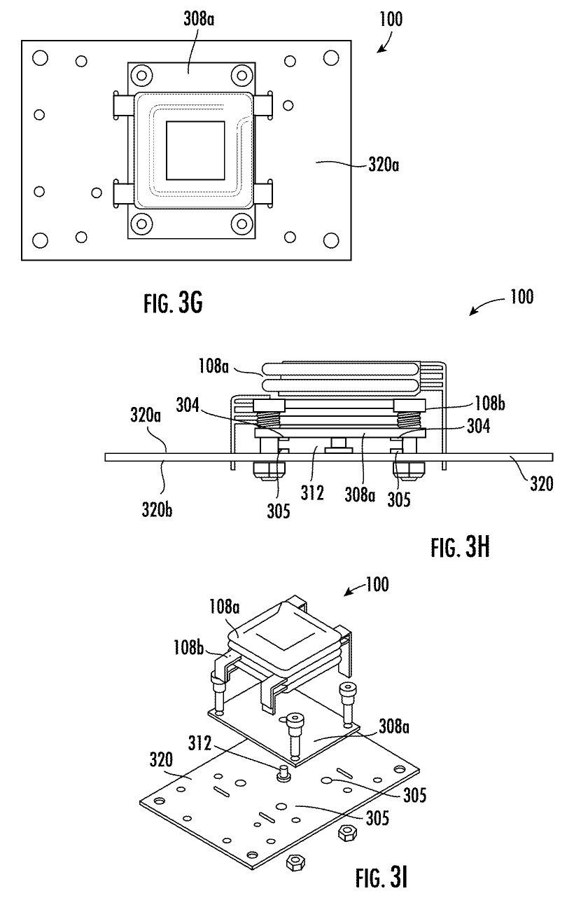

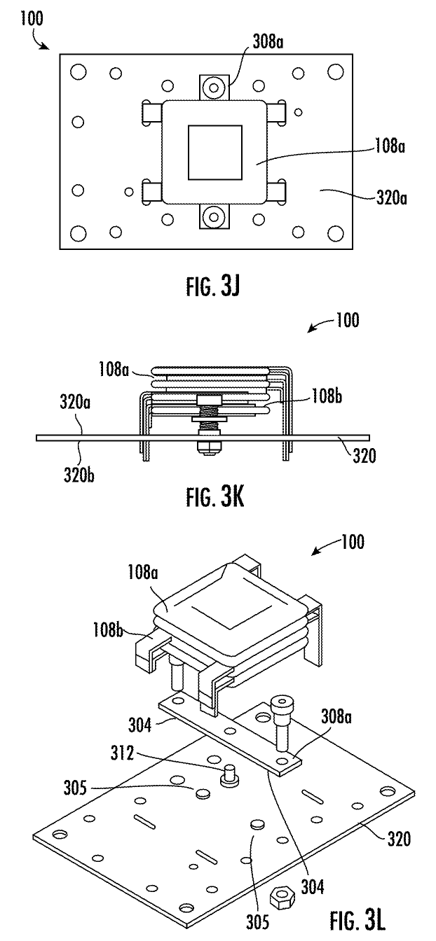

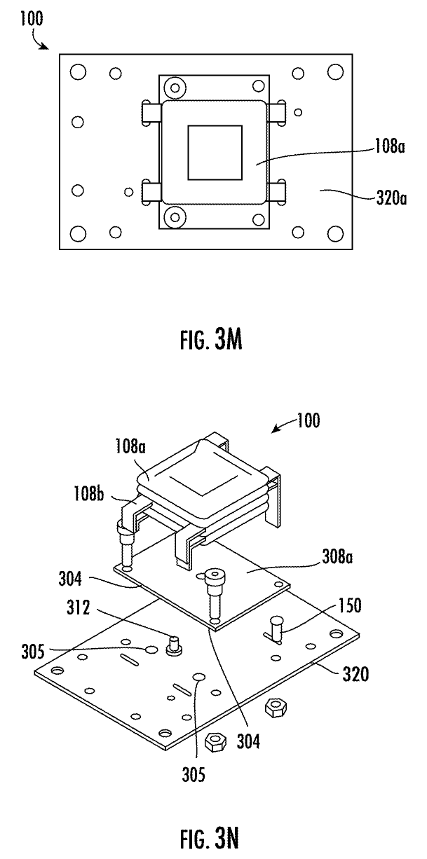

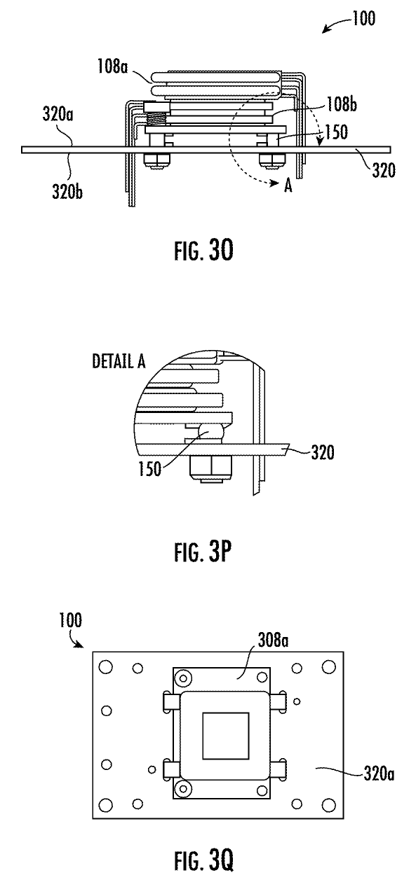

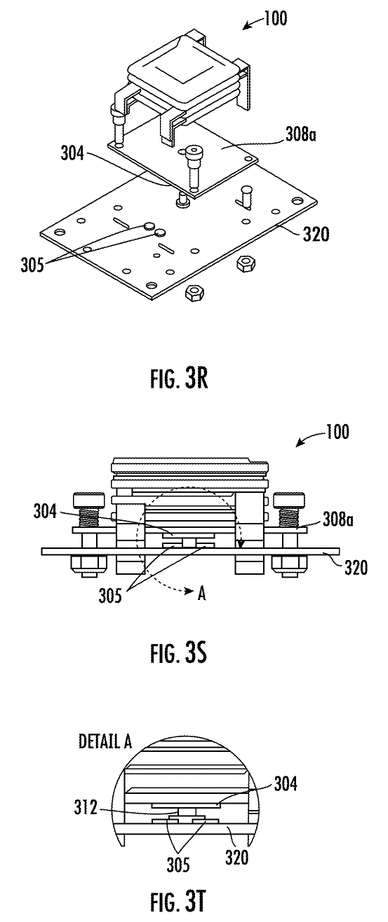

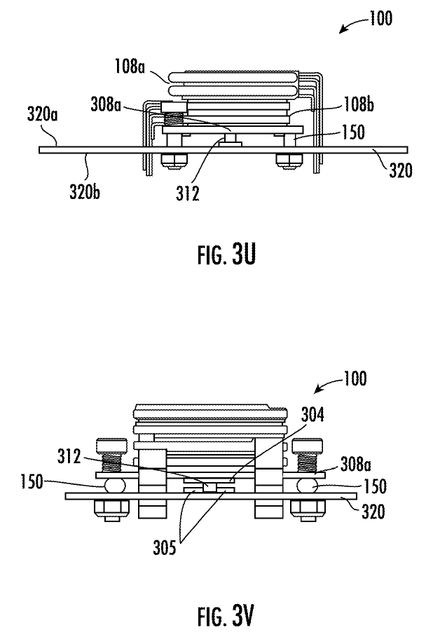

FIGS. 3A-E show various views of an overvoltage protection device 100 in accordance with at least one embodiment of the present disclosure. Specifically, FIG. 3A shows a top view of an overvoltage protection device 100. FIG. 3B shows a perspective view of the overvoltage protection device 100. FIG. 3C shows a front view of the overvoltage protection device 100. FIG. 3D shows a side view of the overvoltage protection device 100. FIG. 3E shows an exploded view of the overvoltage protection device 100. FIG. 3F shows a failsafe component 110 in accordance with at least one example embodiment of the present disclosure.

The depiction of the overvoltage protection device 100, including the failsafe component 110 thereof, is not intended to limit or otherwise confine the embodiments described and contemplated herein to any particular configuration nor is it intended to exclude any alternative configuration that can be used in connection with embodiments of the present disclosure. It will be understood that while many of the aspects and components presented in FIGS. 3A-F are shown as discrete, separate elements, other configurations may be used in connection with the methods, devices, apparatuses, and systems described herein, including configurations that combine, omit, separate, and/or add aspects and/or components.

The overvoltage protection device 100 comprises a failsafe component 110. In the illustrated embodiment of FIGS. 3A-F, the failsafe component 110 is mounted or otherwise disposed between a first overvoltage protection component set 108a and a second overvoltage protection component set 108b. It will be appreciated that in some other embodiments, the failsafe component 110 may be disposed in other position(s) (e.g., the failsafe component 110 may not be positioned between the first overvoltage protection component set 108a and the second overvoltage protection component set 108b). In some embodiments, the failsafe component 110 is disposed below relative to the first overvoltage protection component set 108a and the second overvoltage protection component set 108b. In the illustrated embodiment of FIGS. 3A-F, the first overvoltage protection component set 108a comprises a first pair of varistors (e.g., MOVs or the like) and the second overvoltage protection component set 108b comprises a second pair of varistors. In some embodiments, the varistors comprise disk-shaped MOVs, rectangular-shaped MOVs, or any MOV of desired shape and/or type. The first overvoltage protection component set 108a (e.g., first pair of varistors) and the second overvoltage protection component set 108b (e.g., second pair of varistors) are stacked relative to each and define a space therebetween configured to receive the failsafe component 110.

The first overvoltage protection component set 108a and the second overvoltage protection component set 108b are mounted and/or disposed on a main substrate 320. In various embodiments, the main substrate 320 is a circuit board such as a printed circuit board (PCB) or a printed wiring board (PWB). The main substrate 320 defines one or more through holes 324 configured to receive the electrical leads 330 of the first overvoltage protection component set 108a and the electrical leads 330 of the second overvoltage protection component set 108b.

The failsafe component 110 comprises a first set of one or more electrical contacts 304 formed and/or disposed on and/or within a surface 306a of a first substrate 308a. In some embodiments, the first set of one or more electrical contacts 304 and the first substrate 308a are stamped formed from a single piece of metal. In various embodiments, the first substrate 308a is a circuit board such as a PCB, a PWB, or a single metal piece. For example, in some embodiments, the first substrate 308a comprises a PCB, a PWB, or a single metal piece. In some embodiments, the first substrate 308a is a thin circuit board. The failsafe component 110 further comprises a second set of one or more electrical contacts 305 formed and/or disposed on and/or within a surface 306b of a second substrate 308b. In some embodiments, the second set of one or more electrical contacts 305 and the second substrate 308b are stamped formed from a single piece of metal. In various embodiments, the second substrate 308b is a circuit board such as PCB, a PWB, or a single metal piece. For example, in some embodiments, the second substrate 308b comprises a PCB, a PWB, or a single metal piece. In some embodiments, the second substrate 308b is a thin circuit board.

In various embodiments, the surface 306a of the first substrate 308a and the surface 306b of the second substrate 308b face each other. In some embodiments, the first substrate 308a defines a through hole 327a configured to receive an end 321 of a jumper cable 326a and the second substrate 308b defines a through hole 327b configured to receive an end 321 of a jumper cable 326b. In some embodiments, the through hole 327a is defined on a portion of the first substrate 308a that is opposite the portion of the second substrate 308b in which the through hole 327b is defined. In some embodiments, the opposing end 322 of the jumper cable 326a is coupled to the main substrate 320 via a first through hole 329a defined by the main substrate 320 and the opposing end 322 of the jumper cable 326b is coupled to the main substrate 320 via a second through hole 329b defined by the main substrate 320. In some embodiments, the first substrate 308a, the first set of one or more electrical contacts 304, and the jumper cable 326a may be integrated or otherwise embodied by a single component. For example, in some embodiments, the first substrate 308a, the first set of one or more electrical contacts 304, and the jumper cable 326a may be combined into a first single component such as a first single formed thick foil component. In some embodiments, the second substrate 308b, the second set of one or more electrical contacts 305, and the jumper cable 326b may be integrated or otherwise embodied by a single component. For example, in some embodiments, the second substrate 308b, the second set of one or more electrical contacts 305, and the jumper cable 326b may be combined into a second single component such as a second single formed thick foil component. In various embodiments, the failsafe component 110 is secured to the main substrate 320 via one or more fastening members 340 (e.g., bolts 342, nuts 344, and/or the like).

In some embodiments, the first set of one or more electrical contacts 304 comprises a single electrical contact 304 formed and/or disposed on and/or within the surface 306a of the first substrate 308a and the second set of one or more electrical contacts 305 comprises a single electrical contact 305 formed and/or disposed on and/or within the surface 306b of the second substrate 308b, wherein the single electrical contact 304 and the single electrical contact 305, collectively, form an electrical contact pair.

In some embodiments, the first set of one or more electrical contacts 304 comprises two or more electrical contacts 304 formed and/or disposed on and/or within the surface 306a of the first substrate 308a and the second set of one or more electrical contacts 305 comprises two or more electrical contacts 305 formed and/or disposed on and/or within the surface 306b of the second substrate 308b. In such some embodiments, the two or more electrical contacts 304 and the two or more electrical contacts 305, collectively, form two or more electrical contact pairs with each electrical contact pair comprising an electrical contact 304 and an electrical contact 305.

In various embodiments, an electrical contact (e.g., electrical contact 304 and electrical contact 305) comprise electrically conductive material such as metal or other conductive material. During normal operation (e.g., absence of a device failure condition), the first set of one or more electrical contacts 304 and the second set of one or more electrical contacts 305 are spaced apart from each other such that the electrical contacts thereof do not come in contact. In this regard, the failsafe component 110 is in a non-conductive configuration during normal operation. In particular, as shown in FIG. 3F, the first set of one or more electrical contacts 304 and the second set of one or more electrical contacts 305 collectively define at least one electrical contact pair comprising electrical contacts. The electrical contacts in an electrical contact pair may be aligned relative to each other and spaced apart (e.g., spaced apart during normal operation). By way of non-limiting example, the electrical contacts in an electrical contact pair may be vertically aligned. By way of another non-limiting example, the electrical contacts in an electrical contact pair may be horizontally aligned. As described herein, an electrical contact pair comprises an electrical contact 304 formed/disposed on and/or in the surface 306a (e.g., contact surface thereof) of the first substrate 308a and an electrical contact 305 formed/disposed on and/or in the surface 306b (e.g., contact surface thereof) of the second substrate 308b that are aligned relative to each other.

In some embodiments, as shown in FIG. 3F, the first set of one or more electrical contacts 304 and the second set of one or more electrical contacts 305 may define a first electrical contact pair 310a and a second electrical contact pair 310b, each comprising an electrical contact 304 and an electrical contact 305 that are aligned relative to each other and spaced apart during normal operation (e.g., absence of a device failure condition). It will be appreciated that the first set of one or more electrical contacts 304 may comprise any number of electrical contacts 304 and the second set of one or more electrical contacts 305 may comprise any number of electrical contacts, such that any number of electrical contact pairs may be formed (e.g., one electrical contact pair, four electrical contact pairs, six electrical contact pairs, and/or the like). In some embodiments, the number of electrical contact(s) 304 in the first set of one or more electrical contacts 304 may be the same as the number of electrical contact(s) 305 in the second set of one or more electrical contacts 305.

In some embodiments, the number of electrical contact(s) 304 in the first set of one or more electrical contacts 304 may be different from the number of electrical contact(s) 305 in the second set of one or more electrical contacts 305. By way of non-limiting example, in some embodiments, the number of electrical contact(s) 304 in the first set of one or more electrical contacts 304 is less than the number of electrical contact(s) 305 in the second set of one or more electrical contacts 305. By way of another non-limiting example, in some embodiments, the number of electrical contact(s) 304 in the first set of one or more electrical contacts 304 is greater than the number of electrical contact(s) 305 in the second set of one or more electrical contacts 305.

In some embodiments, the electrical contact(s) 304 in the first set of one or more electrical contacts 304 and the electrical contact(s) 305 in the second set of one or more electrical contacts 305 may be the same electrical contact type. In some embodiments, the electrical contact(s) 304 in the first set of one or more electrical contacts 304 and the electrical contact(s) 305 in the second set of one or more electrical contacts 305 may be different electrical contact types.

The failsafe component 110 comprises a spacer 312 mounted and/or disposed between the surface 306a of the first substrate 308a and the surface 306b of the second substrate 308b. The spacer 312 is configured to space and insulate the first set of one or more electrical contacts 304 and the second set of one or more electrical contacts 305 from each other during normal operation. In other words, during normal operation, the first set of one or more electrical contacts 304 and the second set of one or more electrical contacts 305 are spaced apart and insulated from each other via the spacer 312.

In some embodiments, the spacer 312 is formed from or otherwise comprise insulating material. In some embodiments, the spacer 312 is formed from or otherwise comprise copper. In some other embodiments. the spacer 312 may be formed from and/or comprise other types of material. In various embodiments, the spacer 312 comprises a body 312a and a base 312b. The body 312a extends from the base 312b and has a height. The body 312a defines a first end of the spacer 312 and the base 312b defines a second end of the spacer 312. In various embodiments, the body 312a and/or base 312b has a cylindrical shape. In various embodiments, the base 312b has a width and/or diameter that is larger than the width and/or diameter of the body 312a. It will be appreciated that in some embodiments, the spacer 312 may have a different configuration. For example, in some embodiments, the body 312a and/or base 312b may have other shapes (e.g., rectangular shape, spherical shape, irregular shape, or the like) and the shape of the body 312a may be different or the same as the shape of the base 312b. As another example, in some embodiments, the body 312a and the base 312b may have substantially the same width and/or diameter. In some embodiments, the spacer 312 is substantially symmetrical. In this regard, in some embodiments, the spacer 312 may not comprise a base 312b. For example, in some embodiments, the spacer 312 comprises a body 312a that defines the length of the spacer 312. In such some embodiments, the body 312a may define the first end and the second end of the spacer. In such some embodiments, the body 312a may have a cylindrical shape or other suitable shape (e.g., rectangular shape, spherical shape, irregular shape, or the like).

In various embodiments, the first substrate 308a is positioned above the second substrate 308b and defines a through hole configured to receive the first end of the spacer 312. In various embodiments, the through hole defined by the first substrate 308a surrounds a portion of the body 312a. In some embodiments, the first end of the spacer 312 is disposed within the through hole defined by the first substrate 308a such that the through hole defined by the first substrate 308a surrounds at least a portion of the first end (e.g., at least a portion of the body 312a defining the first end thereof). The through hole, for example, may have an interior that surrounds the first end of the spacer (e.g., when the spacer is coupled to the first substrate 308a). In some embodiments, the first end of the spacer 312 extends outwardly (e.g., away from the surface 306a) through the through hole defined by the first substrate 308a.

In some embodiments, the second end of the spacer 312 is disposed on the surface 306b of the second substrate 308b. In some embodiments, the second substrate 308b defines a through hole configured to receive the second end of the spacer 312 or otherwise at least a portion of the base 312b. The second end of the spacer 312 may be disposed within the through hole defined by the second substrate 308b such that the through hole defined by the second substrate 308b surrounds at least a portion of the second end (e.g., at least a portion of the body 312a defining a second end thereof or at least a portion of the base 312b in some embodiments). The through hole, for example, may have an interior that surrounds the second end of the spacer (e.g., when the spacer is coupled to the second substrate 308b). In some embodiments, the second end of the spacer 312 extends outwardly (e.g., away from the surface 306b) through the through hole defined by the second substrate 308b.

In various embodiments, the first end of the spacer 312 is coupled to the first substrate 308a via a thermal sensitive component 315. Alternatively, or additionally, in various embodiments, the second end of the spacer 312 is coupled to the second substrate 308b via a thermal sensitive component, such as the thermal sensitive component 315. For example, one or both of the first substrate 308a or the second substrate 308b may be coupled to the spacer 312 (e.g., at the first end or second end of the spacer 312 respectively) via a thermal sensitive component 315. In various embodiments, the thermal sensitive component 315 comprise a meltable material having a melting temperature that is equal to or less than a threshold temperature (e.g., discussed above). In some embodiments, the threshold temperature is the substantially the same as the melting temperature of the thermal sensitive component 315. In some embodiments, the thermal sensitive component 315 is formed from a conductive material such as metal alloy. For example, the thermal sensitive component may comprise a low temperature melting alloy. In some embodiments, the thermal sensitive component 315 is formed from solder material.

In some embodiments, the thermal sensitive component 315 is substantially annular (or has an annular profile) and at least partially surrounds the spacer 312 (e.g., at or proximate to the first end of the spacer 312 and/or at or proximate to the second end of the spacer 312) during normal operation. It will be appreciated that in some other embodiments, the thermal sensitive component 315 may have other shapes (e.g., rectangular, irregular shape, or the like). In some embodiments, the shape of the thermal sensitive component 315 is dictated or otherwise depends on the shape of the portion of the spacer 312 which it surrounds. In some embodiments, the spacer 312 is coupled to the first substrate 308a at and/or proximate the through hole defined by the first substrate 308a via the thermal sensitive component 315. Alternatively, or additionally, in some embodiments, the spacer 312 is coupled to the second substrate 308b at and/or proximate the through hole defined by the second substrate 308b via the thermal sensitive component 315.

In some embodiments, the first substrate 308a and/or second substrate 308b may not define a through hole configured to receive the spacer 312. In such some embodiments, the spacer 312 may be coupled to the first substrate 308a at the surface 306a of the first substrate 308a via a thermal sensitive component 315. Alternatively, or additionally, in such some embodiments, the spacer 312 may be coupled to the second substrate 308b at the surface 306b of the second substrate 308b via a thermal sensitive component 315.

As described above, during normal operation, the first substrate 308a and the second substrate 308b are spaced apart via the spacer 312 such that the first set of one or more electrical contacts 304 and the second set of one or more electrical contacts 305 do not contact each other. In this regard, during normal operation, the failsafe component 110 is biased to a non- conductive configuration via the spacer 312. In particular, the failsafe component 110 is biased to a non-conductive configuration during normal operation when the spacer 312 is coupled to one or both of the first substrate 308a and the second substrate 308b such that the spacer 312 is in a configuration and/or orientation that space apart the set of electrical contacts 304 and the second set of one or more electrical contacts 305. For example, the failsafe component 110 may be biased to a non-conductive configuration during normal operation when the spacer 312 is coupled to at least one of the first substrate 308a or the second substrate 308b.

A non-conductive configuration of the failsafe component refers to a state of the failsafe component 110 where the first set of one or more electrical contacts 304 and the second set of one or more electrical contacts 305 do not contact each other (e.g., where the electrical contacts of the at least one electrical contact pair defined by the first set of one or more electrical contacts 304 and the second set of one or more electrical contacts 305 do not contact each other). On the other hand, a conductive configuration of the failsafe component refers to a state of the failsafe component 110 where the first set of one or more electrical contacts 304 and the second set of one or more electrical contacts 304 contact each other and cause a short circuit to be created (e.g., where the electrical contacts of the at least one electrical contact pair defined by the first set of one or more electrical contacts 304 and the second set of one or more electrical contacts 305 contact each other and cause a short circuit to be created).

In various embodiments, the first set of one or more electrical contacts 304 and the second set of one or more electrical contacts 305 are biased towards each other via one or more compressible components 350 (e.g., pretensioned springs and/or other compressible components) and/or other biasing mechanisms or techniques, such as applying weight to the first substrate or otherwise using gravity to cause the bias of the electrical contacts towards each other. In this regard, during normal operation, the first set of one or more electrical contacts 304 and the second set of one or more electrical contacts 305 are biased towards each other but spaced apart and insulated from each other via the spacer 312 (e.g., such that the failsafe component 110 is biased to a non-conductive configuration during normal operation). The spacer 312, for example, may be configured to withstand the compressive force of the one or more compressible components when the spacer 312 is coupled to the first substrate 308a and/or the second substrate 308b, whereby the first set of one or more electrical contacts 304 and the second set of one or more electrical contacts 305 do not contact each other. In various embodiments, the one or more compressible components 350 each define a through hole for receiving a fastening member such as a bolt 342 and are positioned above the opposing surface of the first substrate 308a (e.g., the surface of the first substrate opposite the surface comprising the electrical contacts). For example, the bolt 342 may comprise a head portion and a body portion having a length, wherein the body portion is inserted through a through hole defined by the respective compressible component 350 to engage a nut 344 below the main substrate 320. For example, during at least normal operation, the head portion of the bolt 342 may engage the first substrate 308a at a surface of the first substrate 308a opposite the surface 306a of the first substrate 308a, and the nut 344 may engage the surface 320b (e.g., bottom surface) of the main substrate 320 opposite the surface 320a (e.g., upper surface 320a) of the main substrate 320.

The failsafe component 110 is configured to transition from the non-conductive configuration to a conductive configuration in response to device failure condition corresponding to a condition where the overvoltage protection component(s) conduct heat with a temperature that satisfies the threshold temperature. In various embodiments, the thermal sensitive component 315 comprise a meltable material having a melting temperature that is equal to or less than the threshold temperature. In some embodiments, the threshold temperature is substantially the same as the melting temperature of the thermal sensitive component 315. For example, a thermal sensitive component 315 having a melting temperature that is about the same as the threshold temperature may be selected as the thermal sensitive component 315. In an example embodiment, the threshold temperature is about 125° C. In an example embodiment, the thermal sensitive component 315 has a melting temperature in a range of 120 - 125° C. It would be appreciated that in on other embodiments, the threshold temperature may be less than or greater than 125° C. and/or the melting temperature of the thermal sensitive component may be less than 120° C. or greater than 125° C.

In some embodiments, the spacer 312 is formed from a meltable material such that a separate thermally sensitive component may or may not be needed. For example, in some embodiments, the spacer 312 may be formed from a meltable material having a melting temperature that is equal to or less that the threshold temperature and may be disposed between the first substrate 308a and the second substrate 308b such that a first end of the spacer 312 engages the surface 306a of the first substrate 308a and a second end of the spacer 312 engages the surface 306b of the second substrate 308b. In such some embodiments, the spacer 312 may have an annular shape or any other shape.

When the thermal sensitive component 315 is exposed to a temperature that satisfies (e.g., exceeds, is equal to, or the like) the threshold temperature, the thermal sensitive component 315 (or a portion thereof) melts, causing decoupling of the spacer 312 from a substrate(s) (e.g., first substrate 308a and/or second substrate 308b) which it is coupled to. The decoupling (e.g., releasing) of the spacer 312 from the first substrate 308a and/or the second substrate 308b, in turn, causes the failsafe component 110 to transition to the conductive configuration where at least an electrical contact pair (e.g., first electrical contact pair 310a and/or second electrical contact pair 310b) defined by the first set of one or more electrical contacts 304 and the second set of one or more electrical contacts 305 come in contact. For example, when the thermal sensitive component 315 melts due to being exposed to a temperature that satisfies the threshold temperature, the spacer is decoupled or otherwise released from one or both of the first substrate 308a and the second substrate 308b.

Further, when the spacer 312 is decoupled/released from the first substrate 308a and/or the second substrate 308b, the first set of one or more electrical contacts 304 and the second set of one or more electrical contacts 304 which are biased towards each other move towards each other (e.g., based on the first substrate 308a and the second substrate 308b moving towards each other) such that at least one electrical contact pair (e.g., electrical contact pair 310a, electrical contact pair 310b, and/or the like) defined by the first set of one or more electrical contacts 304 and the second set of one or more electrical contacts 304 come in contact. Further, a short circuit is formed/created when the at least one electrical contact pair come in contact. For example, the first set of one or more electrical contacts and the second set of one or more electrical contacts (in a conductive configuration) with the jumper cable 326a and the jumper cable 326b are configured to form/create a short circuit when the failsafe component 110 is in a conductive configuration.

In this regard, in various embodiments, the spacer 312 is configured to decouple from one or both of the first substrate 308a and the second substrate 308b when the thermal sensitive component 315 is exposed to at least a threshold temperature corresponding to the heat generated by the at least one overvoltage protection. Further, the failsafe component 110 is configured to transition to a conductive configuration when the spacer 312 is decoupled from one or both of the first substrate 308a and the second substrate 308b, and create a short circuit configured to interrupt power supply. In particular, when the heat conducted from an overvoltage protection component 108 (e.g., due to failure and/or otherwise end of life of the overvoltage protection component 108) to the failsafe component 110 causes the temperature to rise such that it satisfies (e.g., exceeds, is equal to, or the like) the threshold temperature, the failsafe component 110 transitions from a non-conductive configuration to a conductive configuration that creates a short circuit.

FIGS. 3G-I show various views of an overvoltage protection device 100 in accordance with at least one other example embodiment of the present disclosure. FIG. 3G shows a top view of the overvoltage protection device 100 in accordance with at least one other example embodiment of the present disclosure. FIG. 3H shows a front view of the overvoltage protection device 100 in accordance with at least one other example embodiment of the present disclosure. FIG. 3I shows an exploded view of the overvoltage protection device 100 in accordance with at least one other example embodiment of the present disclosure.

FIGS. 3J-L show various views of an overvoltage protection device 100 in accordance with at least one other example embodiment of the present disclosure. FIG. 3J shows a top view of the overvoltage protection device 100 in accordance with at least one other example embodiment of the present disclosure. FIG. 3K shows a front view of the overvoltage protection device 100 in accordance with at least one other example embodiment of the present disclosure. FIG. 3L shows an exploded view of the overvoltage protection device 100 in accordance with at least one other example embodiment of the present disclosure.

FIGS. 3M-P show various views of an overvoltage protection device 100 in accordance with at least one other example embodiment of the present disclosure., FIG. 3M shows a top view of the overvoltage protection device 100 in accordance with at least one other example embodiment of the present disclosure. FIG. 3N shows an exploded view of the overvoltage protection device 100 in accordance with at least one other example embodiment of the present disclosure FIG. 3O shows a front view of the overvoltage protection device 100 in accordance with at least one other example embodiment of the present disclosure. FIG. 3P shows an enlarged view of a portion of the overvoltage protection device 100 in accordance with at least one other example embodiment of the present disclosure.

FIGS. 3Q-V show various views of an overvoltage protection device 100 in accordance with at least one other example embodiment of the present disclosure. FIG. 3Q shows a top view of the overvoltage protection device 100 in accordance with at least one other example embodiment of the present disclosure. FIG. 3R shows an exploded view of the overvoltage protection device 100 in accordance with at least one other example embodiment of the present disclosure FIG. 3S shows a side view of the overvoltage protection device 100 in accordance with at least one other example embodiment of the present disclosure. FIG. 3T shows an enlarged view of a portion of the overvoltage protection device 100 in accordance with at least one other example embodiment of the present disclosure. FIG. 3U shows a front view of the overvoltage protection device 100 in accordance with at least one other example embodiment of the present disclosure. FIG. 3V shows another side view of the overvoltage protection device 100 in accordance with at least one other example embodiment of the present disclosure.

Referring now to FIGS. 3G-I, 3J-L, 3M-P, and 3Q-V. In some embodiments, the main substrate 320 may embody or otherwise comprise the second substrate 308b. For example, in some embodiments, the main substrate 320 may represent the second substrate 308b such that the failsafe component 110 may not comprise a separate second substrate 308b. In this regard, in some embodiments, the main substrate 320 may be configured to perform the functions of the second substrate 308b as described above with reference to FIGS. 3A-F.

As shown in illustrated embodiment of FIGS. 3G-I, 3J-L, 3M-P, and 3Q-V, the failsafe component 110 may be disposed below relative to both the first overvoltage protection component set 108a and second overvoltage protection component set 108b. For example, in the illustrated embodiment of FIGS. 3G-V, the failsafe component 110 may be disposed below relative to the second overvoltage protection component set 108b, wherein the second overvoltage protection component set 108b may be disposed above relative to the first overvoltage protection component set 108a. In this regard, in some embodiments, the failsafe component 110 may be disposed below a stack of overvoltage protection components, such as for example, below a stack of MOVS.

In the illustrated embodiments of FIGS. 3G-I, 3J-L, 3M-P, and 3Q-V, the second set of one or more electrical contacts 305 may be formed and/or disposed on the main substrate 320 (e.g., surface 320a thereof). In the illustrated embodiments of FIGS. 3G-I, 3J-L, 3M-P, and 3Q-V, the spacer 312 may be coupled to the main substrate 320 (e.g., surface 320a thereof). In the illustrated embodiments of FIGS. 3G-I, 3J-L, 3M-P, and 3Q-V, one or more other components coupled to the second substrate 308b, as described with reference to FIGS. 3A-F, may be coupled to the main substrate 320.

As shown in the illustrated embodiment of FIGS. 3G-I, in some embodiments, the first set of one or more electrical contacts 304 formed and/or disposed on and/or within the surface 306a of the first substrate 308a may comprise four electrical contacts and the second set of one or more electrical contacts 305 formed and/or disposed on and/or within the main substrate 320 (e.g., upper surface 320a of the main substrate 320) may comprise four electrical contacts 305. It will be appreciated that in some embodiments, the first set of one or more electrical contacts 304 may comprise more or less than four electrical contacts 304 and the second set of one or more electrical contacts 305 may comprise more or less than four electrical contacts 305.

As shown in the illustrated embodiments of FIGS. 3J-L and 3M-P, in some embodiments, the first set of one or more electrical contacts 304 formed and/or disposed on and/or within the surface 306a of the first substrate 308a may comprise two electrical contacts and the second set of one or more electrical contacts 305 formed and/or disposed on and/or within the main substrate 320 (e.g., upper surface 320a of a main substrate 320) may comprise two electrical contacts 305.

As shown in the illustrated embodiment of FIGS. 3J-L, in some embodiments, the electrical contacts (e.g., first set of one or more electrical contacts 304 formed and/or disposed on and/or within the surface 306a of the first substrate 308a and/or the second set of one or more electrical contacts 305 formed and/or disposed on and/or within the main substrate 320) may be positioned at a middle portion relative to the first substrate 308a and/or relative to the main substrate 320. For example, in some embodiments, the first set of one or more electrical contacts 304 may be formed and/or disposed on and/or within a middle portion of the first substrate (e.g., middle portion of the surface 306a of the first substrate 308a) and/or the second set of one or more electrical contacts 305 may be formed and/or disposed on and/or within a middle portion of the main substrate 320 (e.g., at a middle portion of an upper surface 320a of a main substrate 320).

As shown in the illustrated embodiment of FIGS. 3M-P, in some embodiments, the electrical contacts (e.g., first set of one or more electrical contacts 304 formed and/or disposed on and/or within the surface 306a of the first substrate 308a and/or the second set of one or more electrical contacts 305 formed and/or disposed on and/or within the main substrate 320) may be positioned at an end portion relative to the first substrate 308a. For example, in some embodiments, the first set of one or more electrical contacts 304 may be formed and/or disposed on and/or within a first end portion of the first substrate 308a (e.g., at a first end portion of the surface 306a of the first substrate 308a).

As further shown in the illustrated embodiment of FIGS. 3M-P, the failsafe component 110 may comprise one or more pivot members 150. The one or more pivot members 150 may be configured to support the first substrate 308a. As shown in FIGS. 3O-Q, at least a portion of a pivot member 150 may be positioned between the first substrate 308a and the main substrate 320.

As shown in the illustrated embodiment of FIGS. 3Q-V, in some embodiments, the first set of one or more electrical contacts 304 formed and/or disposed on and/or within the surface 306a of the first substrate 308a may comprise a single electrical contact and the second set of one or more electrical contacts 305 formed and/or disposed on and/or within the main substrate 320 (e.g., upper surface of a main substrate 320) may comprise at least two electrical contacts 305. For example, in some embodiments, the number of electrical contacts formed and/or disposed on and/or within the first substrate 308a may be less than the number of electrical contacts formed and/or disposed within the main substrate 320. As shown in FIGS. 3S-T, the single electrical contact 304 formed and/or disposed on and/or within the first substrate 308a may be positioned above the at least two electrical contacts 305 such that when the first substrate 308a and the main substrate move towards each other, the single electrical contact comes in contact with the at least two electrical contacts 305. As further shown in FIGS. 3S and 3T, the single electrical contact 304 may have a length that is longer than a length of each of the at least two electrical contacts 305.

As shown in the illustrated embodiment of FIGS. 3Q-V, the electrical contacts (e.g., single electrical contact 304 formed and/or disposed on and/or within the surface 306a of the first substrate 308a and/or the at least two electrical contacts 305 formed and/or disposed on and/or within the main substrate 320) may be positioned at an end portion relative to the first substrate 308a. For example, in some embodiments, the single electrical contact 304 may be formed and/or disposed on and/or within a first end portion of the first substrate 308a (e.g., at a first end portion of the surface 306a of the first substrate 308a).

As further shown in the illustrated embodiment of FIGS. 3Q-V, the failsafe component 110 may comprise one or more pivot members 150. The one or more pivot members 150 may be configured to support the first substrate 308a. As shown in FIGS. 3R and 3U-V, at least a portion of a pivot member 150 may be positioned between the first substrate 308a and the main substrate 320.

In various embodiments, the failsafe component 110 is a thin failsafe component (e.g., comprising thin circuit boards). In this regard, the first overvoltage protection component set 108a above the failsafe component 110 as well as the overvoltage protection component set 108b below the failsafe component 110 are positioned in close proximity to the failsafe component 110 which, advantageously, allows the failsafe component 110 to react quickly when any of the overvoltage protection components is at its end of life or otherwise fails. Specifically, when any of the overvoltage protection components 108 is at its end of life, heat generated by the respective overvoltage protection component 108 is quickly conducted to the failsafe component 110 based on the close proximity of the overvoltage protection component 108 to the failsafe component 110 (hence, the thermal sensitive component 315 thereof). This, in turn, causes the failsafe component 110 to be substantially in lock step with the one or more overvoltage protection components 108 with respect to the heat generated by an overvoltage protection component 108, such that the failsafe component 110 (e.g., the thermal sensitive component 315 thereof) is exposed to, in real- time or near real-time, a temperature that corresponds to the heat generated by the overvoltage protection component 108. For example, the heat generated by an overvoltage protection component 108 may be quickly conducted to the thermal sensitive component 315 at least because of the close proximity of the thermal sensitive component 315 to the one or more overvoltage protection components 108 due to the thin configuration thereof.

In some embodiments, the overvoltage protection device 100 comprises a housing configured to house various components (or portion thereof) of the overvoltage protection device 100. For example, the one or more overvoltage protection components 108 and/or the failsafe component 110 may be housed or otherwise partially enclosed within the housing. The housing may be made from plastic and/or other suitable materials.

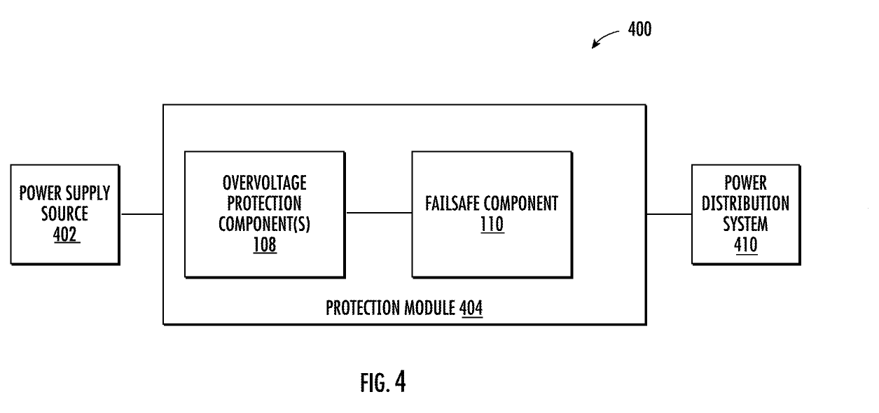

FIG. 4 shows a schematic diagram of an overvoltage protection system 400 in accordance with at least one embodiment of the present disclosure. The depiction of the overvoltage protection system 400 is not intended to limit or otherwise confine the embodiments described and contemplated herein to any particular configuration nor is it intended to exclude any alternative configuration that can be used in connection with embodiments of the present disclosure. It will be understood that while many of the aspects and components presented in FIG. 4 are shown as discrete, separate elements, other configurations may be used in connection with the methods, devices, apparatuses, and systems described herein, including configurations that combine, omit, separate, and/or add aspects and/or components.

In various embodiments, the overvoltage protection system 400 comprises the overvoltage protection device 100 or otherwise an implementation of the overvoltage protection device 100. In some embodiments, the overvoltage protection system 400 is configured to function at least in part as a surge protective system (e.g., a surge protector).

In the illustrated embodiment of FIG. 4, the overvoltage protection system 400 comprises a protection module 404 connected between a power supply source 402 and power distribution system 410. The power distribution system 410 may be configured for delivering power to one or more electrical equipment and/or may comprise one or more electrical equipment. The protection module 404 comprises one or more overvoltage protection components 108 (as described above) and a failsafe component 110 (as described above).

Many modifications and other embodiments of the invention set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the application.

1. An overvoltage protection device comprising:
one or more overvoltage protection components, wherein at least one overvoltage protection component of the one or more overvoltage protection components generates heat when at its end of life; and
a failsafe component in thermal communication with the one or more overvoltage protection components, the failsafe component comprising:
a first set of one or more electrical contacts on a first surface of a first substrate;
a second set of one or more electrical contacts on a second surface of a second substrate, wherein the first surface and the second surface face each other; and
a spacer between the first surface and the second surface configured to space apart the first set of one or more electrical contacts and the second set of one or more electrical contacts when the spacer is coupled to at least one of the first substrate or the second substrate via a thermal sensitive component such that the failsafe component is biased to a non-conductive configuration;
wherein the spacer is configured to decouple from one or both of the first substrate and the second substrate when the thermal sensitive component is exposed to at least a threshold temperature corresponding to the heat generated by the at least one overvoltage protection component to cause the failsafe component to transition to a conductive configuration; and
wherein the first set of one or more electrical contacts and the second set of one or more electrical contacts are in contact with each other when in the conductive configuration and create a short circuit to interrupt power supply.

2. The overvoltage protection device of claim 1, wherein each of the one or more overvoltage protection components comprises a varistor.

3. The overvoltage protection device of claim 2, wherein at least one of the one or more overvoltage protection components comprises an MOV.

4. The overvoltage protection device of claim 1, wherein each of the first substrate and the second substrate comprises a circuit board.

5. The overvoltage protection device of claim 1, wherein the thermal sensitive component comprises a low temperature melting alloy.

6. The overvoltage protection device of claim 1, wherein the thermal sensitive component has a melting temperature that is less than or equal to the threshold temperature.

7. The overvoltage protection device of claim 1, wherein the spacer comprises a first end and a second end.

8. The overvoltage protection device of claim 7, wherein the spacer is coupled to the first substrate when the failsafe component is biased to a non-conductive configuration, and wherein the first substrate is positioned above relative to the second substrate and defines a through hole having an interior that surrounds the first end of the spacer when the spacer is coupled to the first substrate.

9. The overvoltage protection device of claim 1, wherein the failsafe component further comprises a compressible component configured to bias the first surface of the first substrate and the second surface of the second substrate towards each other.

10. The overvoltage protection device of claim 1, wherein the first set of one or more electrical contacts and the second set of one or more electrical contacts define at least one electrical contact pair comprising a first electrical contact and a second electrical contact that are aligned relative to each other.

11. The overvoltage protection device of claim 1, wherein the one or more overvoltage protection components form a stack of overvoltage protection components comprising a first overvoltage protection component set and a second overvoltage protection component set.

12. The overvoltage protection device of claim 1, wherein the overvoltage protection device further comprises a third substrate, wherein each of the one or more overvoltage protection components and the failsafe component is coupled to the third substrate.

13. The overvoltage protection device of claim 12, wherein the failsafe component further comprises:
a first jumper cable coupled to the first substrate and the third substrate; and
a second jumper cable coupled to the second substrate and the third substrate.

14. The overvoltage protection device of claim 12, wherein the third substrate comprises a circuit board.

15. The overvoltage protection device of claim 1, wherein the spacer is made from copper.

16. The overvoltage protection device of claim 1, wherein the threshold temperature is about 125° C.

17. The overvoltage protection device of claim 1, wherein at least a first portion of the one or more overvoltage protection components is electrically coupled between a powered line and a return line, and wherein at least a second portion of the one or more overvoltage protection components is electrically coupled between the return line and an electrical ground.

18. The overvoltage protection device of claim 17, wherein the powered line and the return line are connected to a power supply system configured to supply power to electrical equipment.

19. The overvoltage protection device of claim 18, wherein the power supply system is a telecommunications power supply system.

20. The overvoltage protection device of claim 1, wherein the overvoltage protection device further comprises a housing configured to house the one or more overvoltage protection components and the failsafe component.
